(19) United States
(12) Patent Application Publication
(10) Pub. No.: US 2026/0038174 A1
(43) Pub. Date: Feb. 5, 2026

(54) IMAGE PROCESSING METHOD AND APPARATUS, ELECTRONIC DEVICE AND STORAGE MEDIUM

(71) Applicant: Beijing Zitiao Network Technology Co., Ltd., Beijing (CN)

(72) Inventors: Jiyang LIU, Beijing (CN); Pengxiang YAN, Beijing (CN)

(21) Appl. No.: 19/288,454

(22) Filed: Aug. 1, 2025

(30) Foreign Application Priority Data
Aug. 2, 2024 (CN) 202411061237.0

(51) Int. Cl. G06T 11/60; G06T 5/30; G06T 5/50; G06T 7/11; G06T 13/00

(52) U.S. Cl. CPC G06T 11/60; G06T 5/30; G06T 5/50; G06T 7/11; G06T 13/00; G06T 2207/10016; G06T 2207/20036

(57) ABSTRACT

An image processing method and apparatus, an electronic device and a storage medium are provided. The method includes: acquiring an original image, and the original image including a plurality of elements; obtaining a plurality of first masks based on the original image, and different first masks corresponding to different elements; determining a correspondence between the first masks and frame numbers of a target video; and obtaining the target video, based on the correspondence between the first masks and the frame numbers of the target video, and the original image. In the target video, with a gradual progress of each frame of a picture, new elements continuously emerge.

### CROSS-REFERENCE TO RELATED APPLICATION

This application claims the priority to and benefits of the Chinee Patent Application, No. 202411061237.0, which was filed on Aug. 2, 2024. All the aforementioned patent applications are hereby incorporated by reference in their entireties.

### TECHNICAL FIELD

The present disclosure relates to the technical field of image processing, and in particularly to an image processing method and apparatus, an electronic device and a storage medium.

### BACKGROUND

With the rapid development of digital image technology, people put forward higher requirements for the visual effects of image. In order to increase the appreciation and artistry of image, adding special effects to image has become an important technical means. Special effects can bring richer visual effects to image, thereby making image more attractive and ornamental.

However, although some software or applications have provided the function of adding special effects, the types of the special effects they provide are limited, which is difficult to meet the diverse needs of users.

### SUMMARY

The present disclosure provides an image processing method and apparatus, an electronic device and a storage medium.

An image processing method is provided by the present disclosure. This method includes:
acquiring an original image, wherein the original image includes a plurality of elements;
obtaining a plurality of first masks based on the original image, wherein different first masks correspond to different elements;
determining a correspondence between the first masks and frame numbers of a target video; and
obtaining the target video, based on the correspondence between the first masks and the frame numbers of the target video, and the original image, wherein, in the target video, with a gradual progress of each frame of a picture, new elements continuously emerge.

An image processing apparatus is also provided by the present disclosure. This apparatus includes:
an acquiring module, configured to acquire an original image, wherein the original image includes a plurality of elements;
a first determination module, configured to obtain a plurality of first masks based on the original image, wherein different first masks correspond to different elements;
a second determination module, configured to determine a correspondence between the first masks and frame numbers of a target video;
a video generation module, configured to obtain the target video, based on the correspondence between the first masks and the frame numbers of the target video, and the original image, wherein in the target video, with a gradual progress of each frame of a picture, new elements continuously emerge.

An electronic device is also provided by the present disclosure. This electronic device includes:
one or more processor;
a memory, configured to store one or more programs,
when the one or more programs are executed by the one or more processors, the method as described above is implemented by the one or more processors.

A computer-readable storage medium is also provided by the present disclosure. The computer-readable storage medium stores at least one computer program, and the computer program, when executed by a processor, is configured to implement the method as described above.

### BRIEF DESCRIPTION OF DRAWINGS

The accompanying drawings, which are incorporated in and constitute a part of this specification, illustrate embodiments consistent with the disclosure and together with the description, serve to explain the principles of the present disclosure.

In order to explain the technical scheme in the embodiments of the present disclosure or the existing art more clearly, the drawings needed in the description of the embodiments or the existing art will be briefly introduced below. Obviously, for ordinary people in the field, other drawings can be obtained according to these drawings without paying creative labor.

FIG. 1 is a flowchart of an image processing method provided by an embodiment of the present disclosure.

FIG. 2 is a schematic diagram of an original image provided by an embodiment of the present disclosure.

FIG. 3 is a schematic diagram of a target video provided by an embodiment of the present disclosure.

FIG. 4 is a flowchart of another image processing method provided by implementation of the present disclosure.

FIG. 5 is a schematic diagram of an image processing method provided by an embodiment of the present disclosure.

FIG. 6 is a first-node diagram provided by an embodiment of the present disclosure.

FIG. 7 is a Gaussian distribution weight map provided by an embodiment of the present disclosure.

FIG. 8 is a schematic diagram of another image processing method provided by an embodiment of the present disclosure.

FIG. 9 is a schematic diagram of another image processing method provided by an embodiment of the present disclosure.

FIG. 10 is a schematic structural diagram of an image processing apparatus provided by an embodiment of the present disclosure.

FIG. 11 is a schematic structural diagram of an electronic device provided by an embodiment of the present disclosure.

### DETAILED DESCRIPTION

In order to understand the above objects, features and advantages of the present disclosure more clearly, the solution of the present disclosure will be further described below. It should be noted that the embodiments of the present disclosure and the features in the embodiments can be combined with each other without conflict.

In the following description, many specific details are set forth in order to fully understand the present disclosure, but the present disclosure may be practiced in other ways than those described herein. Obviously, the embodiments in the specification are only part of the embodiments of the present disclosure, not all of them.

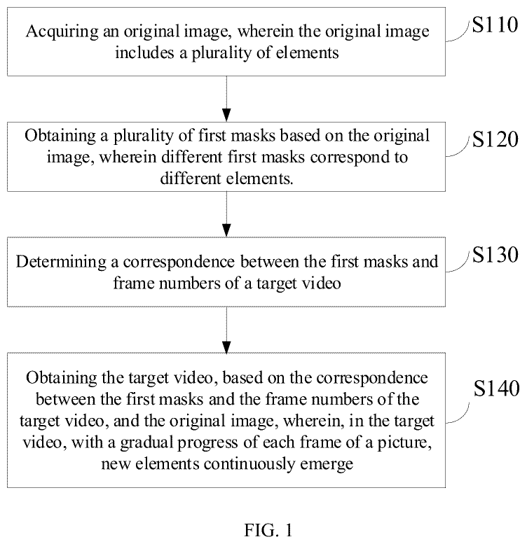

FIG. 1 is a flowchart of an image processing method provided by an embodiment of the present disclosure. This embodiment can be applied to the case of adding special effects to an image in a client and converting the image into video. This method may be executed by an image processing device, which can be implemented in software and/or hardware. This device can be configured in electronic device, such as a terminal, including but not limited to smart phones, palmtop computers, tablet computers, wearable devices with display screens, desktops, notebook computers, all-in-one machines, smart home devices, and the like. Alternatively, this embodiment may be applied to the case of adding special effects to the image in the server and converting the image into video. The method may be executed by an image processing device, which can be implemented in software and/or hardware, and can be configured in electronic device, such as a server.

As shown in FIG. 1, the method may specifically include:

S110: acquiring an original image, wherein the original image includes a plurality of elements.

The original image is a video that needs to be added with special effects, which can be an image shot by a user or an image downloaded from the network.

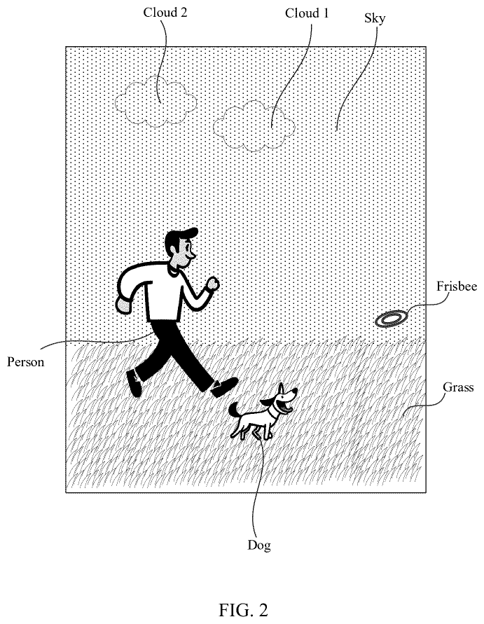

For example, the elements may refer to individuals or units with clear semantic information, identifiable and countable or uncountable in an image, which together constitute the visual content of the image through their respective attribute characteristics, and are the basic objects of image processing and analysis. Especially in the matting task, elements are the targets that need to be accurately extracted and separated. The elements in the original image may specifically include a person, a building, a tree, a vehicle, an animal, the sky or grass in the original image. Illustratively, in the original image provided in FIG. 2, elements include a person, a dog, a frisbee, grass, the sky, cloud 1 and cloud 2.

In some scenes, elements may be divided into a main element and candidate elements. For example, the main element may be an element in the original image that needs to be focused on or wants to be highlighted. Illustratively, the main element may be, for example, a person, a building, a tree, a vehicle, an animal, and so on.

The candidate elements are remaining elements after excluding the main element from all the elements included in the original image.

S120: obtaining a plurality of first masks based on the original image, wherein different first masks correspond to different elements.

The essence of this step is to determine the first mask corresponding to the element according to the region occupied by the element in the original image.

In some scenes, the first mask may be a binary image with the same size as the original image. In the first mask, the pixel value takes a value of 1 or 0. When a certain pixel value is 1, it indicates that the element corresponding to the first mask occupies this pixel. When a certain pixel value is 0, it indicates that the element corresponding to the first mask does not occupy this pixel.

In other scenes, the first mask is a grayscale image with the same size as the original image. In the first mask, the pixel value is any one from 0 to 255. When a certain pixel value is located in the range of 1-255, it indicates that the element corresponding to the first mask occupies the pixel. When a certain pixel value is 0, it indicates that the element corresponding to the first mask does not occupy the pixel.

When performing this step, for the elements included in the original image, it is necessary to determine the first mask corresponding to each element one by one.

S130: determining a correspondence between the first masks and frame numbers of a target video.

The target video may be, for example, a video with specific special effects added, which is desired to be obtained after processing original image, and it is a final result obtained based on the image processing method provided in the present disclosure.

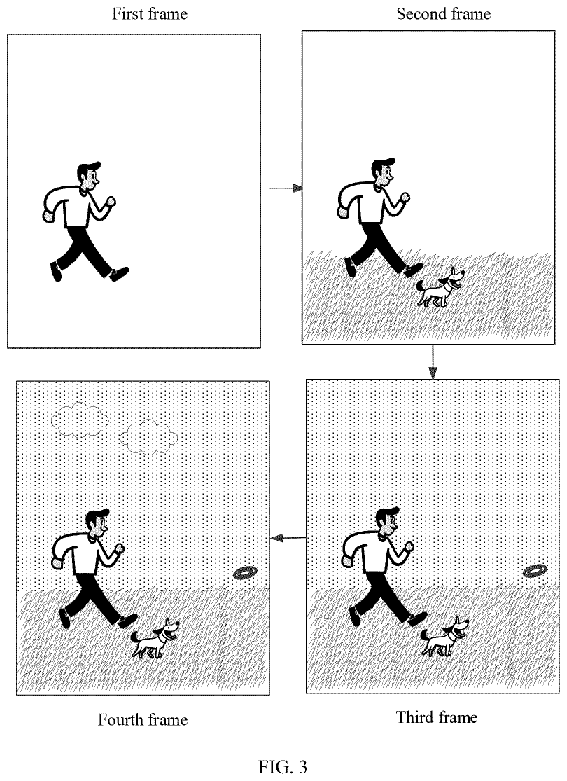

The visual effect of the target video is that in the target video, with the progress of each frame of a picture, new elements continuously emerge. Exemplarily, referring to FIG. 2, the original image reflects a picture of a person and a dog playing a frisbee on the grass. The elements in the original image include a person, a dog, a frisbee, grass, cloud 1, cloud 2 and the sky. Supposing that the target video includes a total of 4 frames of pictures, referring to FIG. 3, only the person is displayed in the first frame; the person, the grass, and the dog are displayed in the second frame; the person, the grass, the dog, the sky, and the frisbee are displayed in the third frame; and the person, the grass, the dog, the sky the frisbee, the cloud 1, and the cloud 2 are displayed in the fourth frame.

It should be noted that the total number of frames of the target video is specified in advance.

Supposing that a total of N first masks are obtained, the i-th first mask corresponds to the i-th element. If the i-th first mask corresponds to the frame number b of the target video, it means that the i-th element is introduced in the b-th frame of the target video, that is, all image frames from the b-th frame to the end of the target video includes the i-th element.

The essence of this step is to sort out all the first masks obtained in S120, and determine in which image frame of the target video each element is introduced.

S140: obtaining the target video, based on the correspondence between the first masks and the frame numbers of the target video, and the original image, wherein, in the target video, with a gradual progress of each frame of a picture, new elements continuously emerge.

Since the correspondence between the first masks and frame numbers of the target video has been obtained, that is, it is clear in which frame of the target video each element is introduced, so that the original image can be matting, and then each frame image of the target video can be made. Then, according to the order of the frame numbers from small to large, each frame image is spliced to get the target video.

The above technical solution includes: acquiring an original image, wherein the original image includes a plurality of elements; obtaining a plurality of first masks based on the original image, wherein different first masks correspond to different elements; determining a correspondence between the first masks and frame numbers of a target video; and obtaining the target video, based on the correspondence between the first masks and the frame numbers of the target video, and the original image, wherein, in the target video, with a gradual progress of each frame of a picture, new elements continuously emerge. Its essence is to give a new special effect, which is obtained by processing the original image, and its effect is to rearrange and adjust the order of the elements in the original image, and finally show that the elements in the target video picture gradually accumulate and the scene level gradually enriches with the passage of time. In this way, it can meet the diverse special effects adding requirements of users.

In general, the number of the first masks determined in S120 is often greater than or equal to the total number of frames of the target video.

When the number of the first masks determined in S120 is equal to the total number of frames of the target video, S130 may be directly executed.

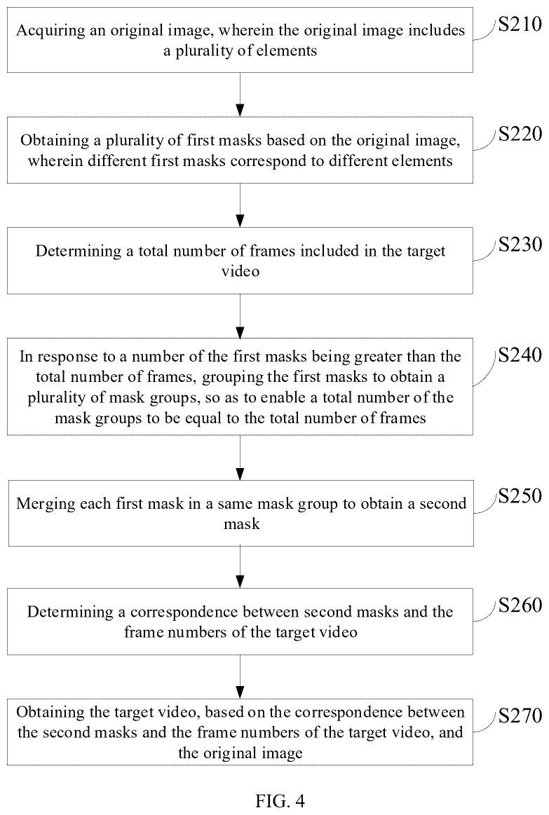

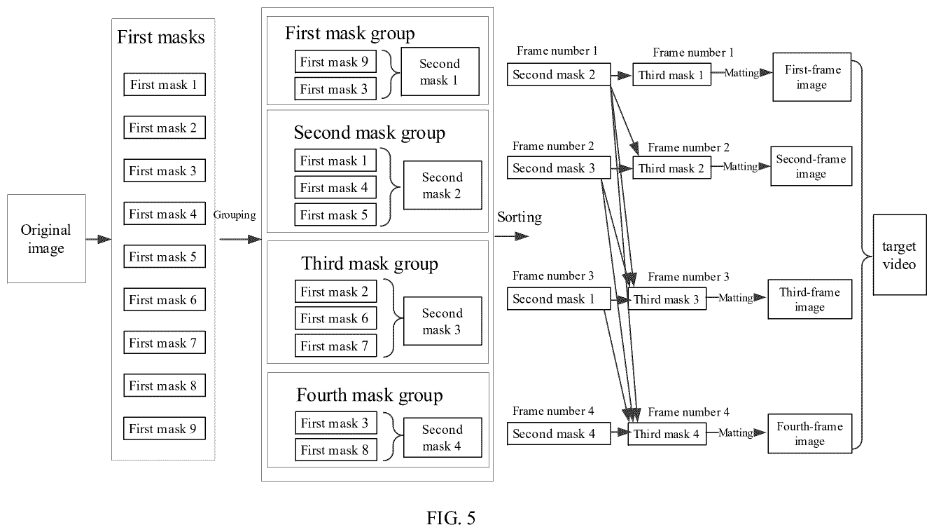

When the number of the first masks determined in S120 is greater than the total number of frames of the target video, optionally, FIG. 4 is a flowchart of another image processing method provided by implementation of the present disclosure. FIG. 5 is a schematic diagram of an image processing method provided by an embodiment of the present disclosure. Referring to FIGS. 4 and 5, the image processing method includes: S210: acquiring an original image, wherein the original image includes a plurality of elements.

S220: obtaining a plurality of first masks based on the original image, wherein different first masks correspond to different elements.

Exemplarily, referring to FIG. 5, based on original image, a total of nine first masks are obtained, namely the first mask 1 to the first mask 9.

S230: determining a total number of frames included in the target video.

S240: in response to a number of the first masks being greater than the total number of frames, grouping the first masks to obtain a plurality of mask groups, so as to enable a total number of the mask groups to be equal to the total number of frames.

In response to the number of the first masks being larger than the total number of frames, if a strategy of introducing a new element into each frame image is designed, the technical solution can't introduce all the elements in the original image until the last frame of a picture of the target video. Therefore, the first masks need to be grouped in order to introduce a plurality of elements in one frame of a picture.

There are many ways to implement this step, which is not limited by the present disclosure. Alternatively, in some embodiments, the first masks may be randomly grouped.

In another embodiment, an adjacency relationship between different first masks and areas of the first masks may be determined firstly; the first masks are grouped based on the adjacency relationship between the different first masks and/or the areas of the first masks to obtain the plurality of mask groups.

The adjacency relationship between the different first masks may be, for example, information reflecting whether elements corresponding to the different first masks are in boundary contact in the original image. When there is an adjacency relationship between two first masks, it means that the corresponding elements of the two first masks are in boundary contact in the original image. When there is no adjacency relationship between two first masks, it means that the elements corresponding to the two first masks have no boundary contact in the original image.

In response to grouping the first masks based on the adjacency relationship between the different first masks, when new elements are finally introduced in each frame, the region occupied by the newly introduced elements in each frame of the target video is enabled to be adjacent to the region occupied by the newly introduced elements in the previous frame, so as to create a visual effect of element continuity.

The mask-group area is defined as the sum of all the areas of the first mask areas in the mask group. In actual grouping, in response to grouping the first masks based on the areas of the first masks, a difference between mask-group areas of different mask groups may be made as small as possible, and when new elements are finally introduced in each frame, the region occupied by the newly introduced elements tends to be consistent, so as to create a balanced and harmonious visual effect.

Optionally, in practice, determining the adjacency relationship between the different first masks and the areas of the first masks may include: performing dilation processing with a preset pixel width on each of the first masks to obtain dilated first masks; determining an overlapping relationship between the dilated first masks; and based on the overlapping relationship between the dilated first masks, determining an adjacency relationship between the different first masks before the dilation processing.

In practice, a first-node diagram may be configured to reflect the adjacency relationship between different first masks.

Taking the first mask as a first node, the first-node diagram is constructed. In the first-node diagram, there is a connection line between the first nodes corresponding to the first masks with an adjacent relationship (that is, the first nodes corresponding to the first masks with an adjacent relationship can reach each other), and there is no connection line between the first nodes corresponding to the first masks without an adjacent relationship (that is, the first nodes corresponding to the first masks without an adjacent relationship are inaccessible to each other).

Exemplarily, referring to FIG. 6, seven first nodes (i.e., circles in FIG. 6) are provided in the first-node diagram, each first node represents an element, different first nodes have different numbers (such as numbers in the circles in FIG. 6), and the numbers of the first nodes are used to distinguish the first nodes. In FIG. 6, some first nodes can reach each other, and some first nodes cannot reach each other. Exemplarily, the elements corresponding to the first node 1 and the first node 5 are in boundary contact in the original image, and there is a connecting line between the first node 1 and the first node 5, and the two can reach each other. When the elements corresponding to the first node 2 and the first node 3 have no boundary contact in the original image, there is no connecting line between the first node 2 and the first node 3, and the two are inaccessible to each other.

Optionally, a weight value of each node may be determined based on the area of the first mask represented by each node. The weight value of each node is not shown in FIG. 6. In this way, the area of the first mask can be represented by the weight value of the node, and then the adjacency relationship between different first masks and the areas of the first masks can be all collected in the first-node diagram. Optionally, the larger the area of the first mask, the greater the weight value of the node corresponding to the first mask.

There are many specific ways to implement the “grouping the first masks based on the adjacency relationship between the different first masks and the areas of the first masks to obtain the plurality of mask groups”. The present disclosure is not limiting to this. Exemplarily, a greedy algorithm may be used to group the first masks based on the adjacency relationship between the different first masks and the areas of the first masks to obtain the plurality of mask groups.

Specifically, supposing that the total number of frames included in the target video is M, M mask groups are set, and each mask group is an empty set in the initial state. Firstly, the first masks are arranged in ascending order based on the areas of the first masks to obtain a first mask queue Mask_list. Secondly, enabling i=1, the grouping operation of the first masks is repeatedly performed until all the first masks are assigned to the mask groups.

The grouping operation of the first masks includes: sorting the current M mask groups in ascending order according to the total area of all the first masks included in the current respective mask groups, to obtain a mask group sequence groups_sort; taking a first mask with a sequence number i from the first mask queue Mask_list; adding the first mask with the sequence number i to the mask group with a sequence number 1 in the mask group sequence groups_sort; starting from sequence number 2 up to sequence number M, sequentially judging whether any two first masks in the mask group (corresponding to sequence numbers from 2 to M in the mask group sequence groups_sort) have an adjacency relationship; when at least part of the first masks in a target mask group do not have an adjacent relationship, adjusting the first mask with the sequence number i to the target mask group, wherein the target mask group is one of mask groups corresponding to the sequence numbers from 2 to M; if, for mask groups corresponding to the sequence numbers from 2 to M, any two first masks in the same mask group are adjacent to each other, keeping the first mask with the sequence number i in the mask group with the sequence number 1; and updating the value of i, so as to enable the difference between the value of i after the update and the value of i before the update to be 1.

Optionally, after “enabling i=1, the grouping operation of the first masks is repeatedly performed until all the first masks are assigned to the mask groups”, the adjacency relationship may be checked for the mask group. Specifically, for any one mask group, all the first masks in the mask group are subjected to second grouping according to whether any two first masks included in the mask group have an adjacent relationship. Each second grouping result is called a connection component, and any two first masks in the same connection component have an adjacent relationship. The total area of each connection component is made equal to the sum of the areas of the first masks included in the connection component. All the connection components in a same mask group are arranged in descending order of total area. It is judged whether any two first masks in another mask group may have an adjacent relationship if the connection component with the second largest total area is moved into another mask group. If any two first masks in another mask group may have the adjacent relationship, the connection component with the second largest total area is moved into another mask group; otherwise, the connection component with the second largest total area is kept in the current mask group.

Exemplarily, referring to FIG. 5, if the total number of frames included in the target video is 4, the nine first masks are divided into four mask groups. Here, the first mask 3 and the first mask 9 belong to one mask group. The first mask 1, the first mask 4, and the first mask 5 belong to one mask group. The first mask 2, the first mask 6, and the first mask 7 belong to one mask group. The first mask 3 and the first mask 8 belong to one mask group.

S250: merging each first mask in a same mask group to obtain a second mask.

The essence of this step is to merge all the first masks in the same mask group into a new mask. The new mask is the second mask.

Since the first mask marks the area occupied by its corresponding element in the original image, merging each first mask in the same mask group means that we integrate the information covered by these individual first masks into the second mask. The second mask marks the region occupied in the original image by the entirety of elements corresponding to all of the first masks from which it is derived. The second mask corresponds to the elements corresponding to all of the first masks from which it is derived.

Exemplarily, referring to FIG. 5, since the first mask 3 and the first mask 9 belong to one mask group, the first mask 3 and the first mask 9 are merged to obtain a second mask 1. Since the first mask 1, the first mask 4, and the first mask 5 belong to one mask group, the first mask 1, the first mask 4, and the first mask 5 are merged to obtain a second mask 2. Since the first mask 2, the first mask 6, and the first mask 7 belong to one mask group, the first mask 2, the first mask 6, and the first mask 7 are merged to obtain a second mask 3. Since the first mask 3 and the first mask 8 belong to one mask group, the first mask 3 and the first mask 8 are merged to obtain a second mask 4.

For the second mask 1, it is obtained by merging the first mask 9 and the first mask 3, the first mask 9 corresponds to the element 9, and the first mask 3 corresponds to the element 3, so the second mask 1 corresponds to both the element 9 and the element 3.

S260: determining a correspondence between second masks and the frame numbers of the target video.

The essence of this step is to determine which elements are introduced in each frame object of the target video.

There are many ways to implement this step, which is not limited by the present disclosure. Exemplarily, in one example, the implementation method of this step may randomly arrange the second masks to obtain a second mask sequence. A second mask with sequence number j in the second mask sequence corresponds to the frame number j of the target video, and then a correspondence between the second mask and the frame number the target video is obtained.

In another embodiment, optionally, a key point is determined based on the original image; a score of each of the second masks is determined based on the key point, wherein the score of each of the second masks is configured to characterize a distance between the second mask and the key point; the second masks are sorted based on the score of each of the second masks to obtain a second mask sequence; and the correspondence between the second masks and the frame numbers of the target video is determined based on a position of each of the second masks in the second mask sequence.

Key point, for example, can be used to guide the user's visual focus position, which will later determine which elements are introduced first and which elements are introduced later. The appropriate determination of key point ensures that in the target video, relatively important elements are introduced first, and secondary elements are introduced later, which can make the target video have a clear visual hierarchy and make the picture information transmission more efficient and orderly.

In practice, if the elements in the original image includes a main element, the key point may be determined based on the location of the main element in original image. Specifically, pixel point that constitutes the geometric center of the main element in the original image, can be taken as the key point. Alternatively, pixel point that constitutes the geometric center of the main element in the original image is taken as an initial point, and the pixel point obtained after the initial point is offset by a preset distance along a preset direction is taken as the key point.

If the elements in the original image do not include a main element, the key point may be determined based on a picture midpoint in the original image. Specifically, pixel point at the picture midpoint in the original image may be regarded as the key point. Alternatively, pixel point at the picture midpoint in the original image is taken as an initial point; and the pixel point obtained after the initial point is offset by a preset distance along a preset direction is taken as the landmark/key point.

The present disclosure does not limit the specific preset direction of the offset and the specific preset distance of the offset. In practice, it can be determined as needed. Exemplarily, for an original image including the ground, the preset direction may be set as downward (that is, the aspect pointing to the ground from the center point of the original image), and the preset distance is 0.1 times height of the original image. This setting can make the key point close to the ground, which can make the introduction order of elements in the target video more natural because the ground often has a supporting function.

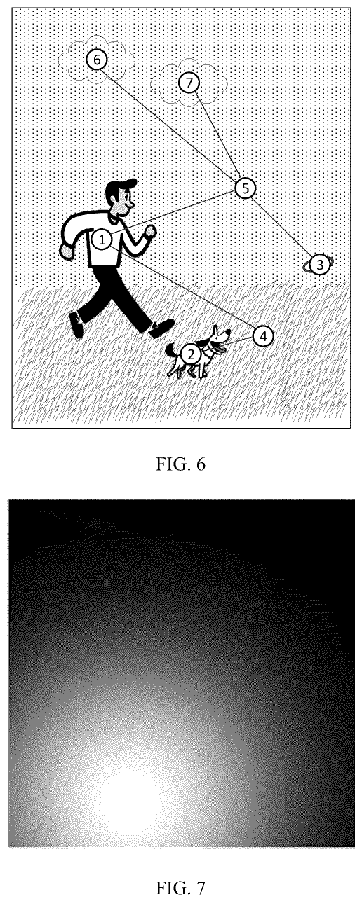

There are many methods to determine the score of the second mask, which is not limited by the present disclosure. Exemplarily, based on the key point, a Gaussian distribution weight map corresponding to the original image may be determined, and a score of each second mask may be determined based on the Gaussian distribution weight map. FIG. 7 shows a Gaussian distribution weight map corresponding to the original image. The Gaussian distribution weight map is obtained based on the original image provided in FIG. 2.

Further, the score scoreᵢ of the i-th second mask may be calculated according to the following form:

$${score}_{i} = \frac{\sum {weight}_{map} * {Mask}_{i}}{\sum {Mask}_{i}}$$

Wherein, weightₘₐₚ is a Gaussian distribution weight map, and Maskᵢ is an area of the i-th second mask. Σweightₘₐₚ*Maskᵢ represents that the Gaussian distribution weight map is applied to the second mask. ΣMaskᵢ is the area of the i-th second mask. The two summations in the above formula refer to pixel-wise summation of the i-th second mask.

There are various specific implementation methods of the “sorting the second masks based on the score of each of the second masks to obtain a second mask sequence”. Optionally, one of the implementation methods may include: sorting the second masks based on the score of each of the second masks and the adjacency relationship between different second masks to obtain a second mask sequence.

Exemplarily and optionally, dilation processing with a preset pixel width is performed on each of the second masks to obtain dilated second masks; an overlapping relationship between the dilated second masks is determined; an adjacency relationship between the different second masks before the dilation processing is determined based on the overlapping relationship between the dilated second masks.

When sorting the second masks, first, the second mask with the largest score can be placed at the front end of the second mask queue, i.e., the first position. Next, from the second masks that are unsorted, the masks that have adjacent relationships with the sorted second mask are selected, and the one with the largest score is selected from these masks that have the adjacent relationships, and then, this second mask with the largest score is inserted in the second mask queue at the position immediately after the sorted second mask, that is, the second position. According to such a rule, the selection and insertion operations are repeated until all the second masks are sorted in a specified order.

S270: obtaining the target video, based on the correspondence between the second masks and the frame numbers of the target video, and the original image.

There are many ways to implement this step, which is not limited by the present disclosure. For example, if the total number of frames of the target video is M, the implementation method of this step may include: enabling n equal to 1, and repeating a following merging step to obtain a third mask corresponding to a frame number n until n=M, wherein the merging step includes: merging all the second masks corresponding to frame numbers from 1 to n to obtain the third mask; performing matting on the original image based on the third mask to obtain a first image corresponding to the third mask; and splicing the first image corresponding to the third mask based on a correspondence between the third mask and the frame number to obtain the target video.

All the second masks corresponding to the frame numbers from 1 to n are merged to obtain the third mask, which means that information covered by all the second masks corresponding to the frame numbers of from 1 to n is integrated into the third mask. The third mask marks the region occupied in the original image by the entirety of elements corresponding to all of the second masks from which it is derived. The third mask corresponds to the elements corresponding to all of the second masks from which it is derived.

Exemplarily, referring to FIG. 5, supposing that the second mask 2 corresponds to the frame number 1, the second mask 3 corresponds to the frame number 2, the second mask 1 corresponds to the frame number 3, and the second mask 4 corresponds to the frame number 4. The second mask 2 is used as the third mask 1, and the third mask 1 corresponds to the frame number 1. The second mask 2 and the second mask 3 are merged as the third mask 2, and the third mask 2 corresponds to the frame number 2. The second mask 2, the second mask 3, and the second mask 1 are merged as the third mask 3, and the third mask 3 corresponds to the frame number 3. The second mask 2, the second mask 3, the second mask 1, and the second mask 4 are merged as the third mask 4, and the third mask 4 corresponds to the frame number 4.

Continuing to refer to FIG. 5, the third mask 2 is obtained by merging the second mask 2 and the second mask 3. The second mask 2 is obtained by merging the first mask 1, the first mask 4, and the first mask 5, wherein the first mask 1 corresponds to the element 1, the first mask 4 corresponds to the element 4, the first mask 5 corresponds to the element 5, and the second mask 2 corresponds to all of the element 1, the element 4, and the element 5. Similarly, the second mask 3 corresponds to all of element 2, element 6, and element 7. Then, the third mask 2 corresponds to the element 1, the element 4, the element 5, the element 2, the element 6, and the element 7.

For example, supposing that four second masks are obtained based on the element image provided in FIG. 2. In the second mask sequence, the second mask at the first position indicates the position of the person, the second mask at the second position indicates the position of the grass and the dog, the second mask at the third position indicates the position of the sky and the frisbee, and the second mask at the fourth position indicates the positions of cloud 1 and cloud 2. The first third-mask is identical to the second mask in the first position, indicating the position of the person. The second third-mask is obtained by merging the second mask in the second position and the second mask in the first position, indicating the positions of the person, the grass and the dog. The third third-mask is obtained by merging the second mask at the third position, the second mask at the second position, and the second mask at the first position, indicating the positions of the person, the grass, the dog, the sky, and the frisbee. The fourth third-mask is obtained by merging the second mask at the fourth position, the second mask at the third position, the second mask at the second position, and the second mask at the first position, indicating the positions of the person, the grass, the dog, the sky, the frisbee, the cloud 1 and the cloud 2. A first-frame image in FIG. 3 may be obtained by matting the original image with the first third-mask. A second-frame image in FIG. 3 may be obtained by matting the original image with the second third-mask. A third-frame image in FIG. 3 may be obtained by matting the original image with the third third-mask. A fourth-frame image in FIG. 3 may be obtained by matting the original image with the fourth third-mask. The fourth frame image in FIG. 3 can be obtained by performing matting on the original image using the fourth third mask. The first-frame image, the second-frame image, the third-frame image and the fourth-frame image are spliced to obtain the target video.

In practice, due to the instability of the matting model, it may not be possible to completely guaranteed that the pixel value of the same pixel in the next-frame image is greater than or equal to the pixel value in the previous-frame image. In view of this, optionally, it is set to correct the pixel value in the next-frame image based on the previous-frame image, which can make the output region in the target video strictly increase frame by frame, thereby enabling natural transitions in the target video.

According to the technical solution, by setting: determining the total number of frames included in the target video; in response to the number of the first masks being greater than the total number of frames, grouping the first masks to obtain the plurality of mask groups, so as to enable the total number of the mask groups to be equal to the total number of frames; merging each first mask in the same mask group to obtain the second mask; determining the correspondence between the second masks and the frame numbers of the target video, and providing a specific method for sorting out the correspondence between the first masks and the frame numbers of the target video. This method can ensure that the final second masks have the one-to-one correspondence with the frame numbers of the target video, and the second masks can cover all elements, thereby ensuring that the target video does not lose elements in the original image.

On the basis of the above technical solution, optionally, when the elements of the original image include a main element and candidate elements optionally, “the determining a score of each of the second masks based on the key point” includes: determining a target second mask and candidate second masks in the second masks, wherein the target second mask corresponds to the main element, and the candidate second masks correspond to the candidate elements; and determining a score of each of the candidate second masks based on the key point. The “sorting the second masks based on the score of each of the second masks to obtain a second mask sequence” includes: determining that the target second mask has a sequence number of 1 in the second mask sequence; for any one candidate second mask of the candidate second masks, determining a sequence number of the candidate second mask in the second mask sequence, based on a score of the candidate second mask and/or an adjacency relationship between the first candidate second mask and a reference second mask, wherein the reference second mask is a second mask whose sequence number has been specified in the second mask sequence.

The target second mask is a second mask corresponding to the main element. The candidate second masks are second masks that do not correspond to the main element but correspond to the candidate elements.

The determining that the target second mask has a sequence number of 1 in the second mask sequence, that is, the target second mask is placed at the front of the second mask queue, that is, the first position.

For any candidate second mask, each of the candidate second masks is sorted based on the score of the candidate second mask, and the adjacency relationship between the candidate second mask and the second masks inserted in the second mask sequence; for example, from the candidate second masks that are unsorted, the masks that have adjacent relationships with the sorted second mask (here, the target second mask) are selected, and the one with a largest score is selected from these masks that have the adjacent relationships, and then, this candidate second mask with the largest score is inserted in the second mask queue at the position immediately after the sorted second mask, that is, the second position. From the candidate second masks that are unsorted, the masks that have adjacent relationships with the sorted second masks (here including the target second mask and the candidate second mask that has been inserted into the second position) are selected, and the one with a largest score is selected from these masks that have the adjacent relationships. Then, this candidate second mask with the largest score is inserted in the second mask queue at the position immediately after the sorted second masks, that is, the third position. In this way, the selection and insertion operations are repeated until all the second masks are sorted in a specified order.

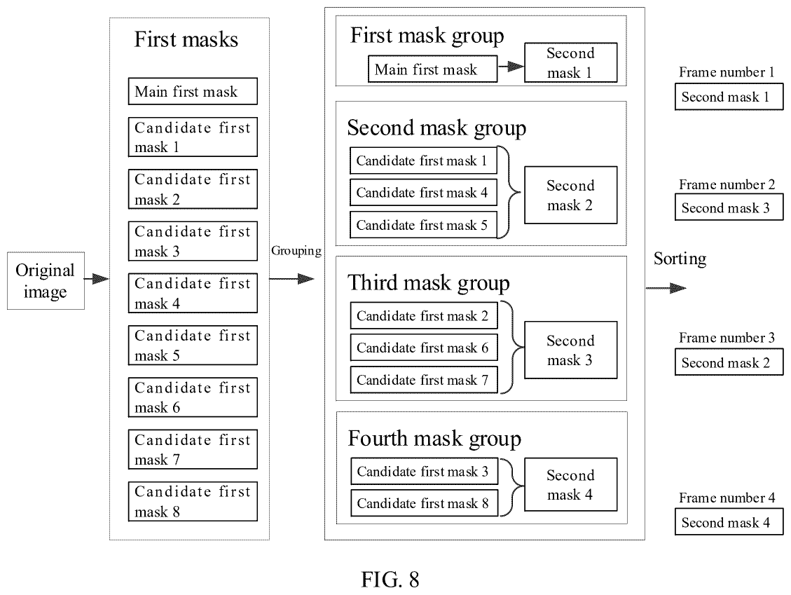

Exemplarily, referring to FIG. 8, supposing that elements in the original image include a main element and candidate elements. Based on the original image, a total of nine first masks are determined, one of which is a main first mask and eight are candidate first masks, the main first mask corresponds to the main element, and the candidate first masks correspond to the candidate elements. Subsequently the main first mask participates in the compositing of the second mask 1, and the second mask 1 is the main second mask. The remaining candidate first masks participate in the compositing of the second masks from 2 to 4, and the second masks 2 to the second masks 4 are all candidate second masks. When sorting the second masks, the second mask 1 is at the first position in the second mask sequence, and the second masks from 2 to 4 are sorted according to the score.

On the basis of the above technical solution, optionally, when the total number of frames of the target video is M, and the elements of the original image include a main element and candidate elements, S240 may include: in response to the number of the first masks being greater than the total number of frames, determining a main first mask and a plurality of candidate first masks among the plurality of first masks, wherein the main first mask corresponds to the main element, and the candidate first masks correspond to the candidate elements; determining a target first mask among the plurality of candidate first masks based on an overlapping relationship between the main first mask and the candidate first masks; compositing the main first mask and the target first mask to obtain a fourth mask; taking the fourth mask as a mask group; determining a number of at least one first reference mask, wherein the first reference mask is a remaining candidate first mask after excluding the target first mask from all the candidate first masks; and in response to the number of the at least one first reference mask being greater than M-1, grouping the at least one first reference mask to obtain M−1 mask groups.

In practice, due to the influence of factors such as the accuracy of the element identification model and specific algorithm logic, there may be overlapping relationships among some of the first masks obtained based on the element identification model. There is an overlapping relationship between two first masks, which may mean, for example, that the two first masks include pixels at the same position. Exemplarily, if pixel 1 is included in original image, the position of the pixel 1 in the original image is determined. When the first mask A1 and the first mask A2 both include the pixel 1, it is considered that there is an overlapping relationship between the first mask A1 and the first mask A2.

Optionally, the overlap degree loFᵢ between the main first mask and the i-th candidate first mask may be determined, and when the overlap degree loFᵢ between the main first mask and the i-th candidate first mask is greater than a set overlap-degree threshold, the i-th candidate first mask may be determined as the target first mask. Subsequently, the main first mask is composited with and the target first mask.

Optionally, the overlap degree loFᵢ between the main first mask and the i-th candidate first mask may be calculated based on the following formula:

$${IoF}_{i} = \frac{\sum ( {Mask}_{s} * {Mask}_{e - i} )}{\sum {Mask}_{e - i}}$$

Wherein, Σ(Maskₛ*Maskₑ₋ᵢ) represents an overlapping area between the main first mask Maskₛ and the i-th candidate first mask Maskₑ₋ᵢ, Maskₑ₋ᵢ represents an area of the i-th candidate first mask Maskₑ₋ᵢ, and the summation refers to pixel-by-pixel summation of the masks.

The present disclosure does not limit the specific value of the set overlap-degree threshold. In practice, it can be set as needed. Exemplarily, the set overlap-degree threshold may be set to 0.5.

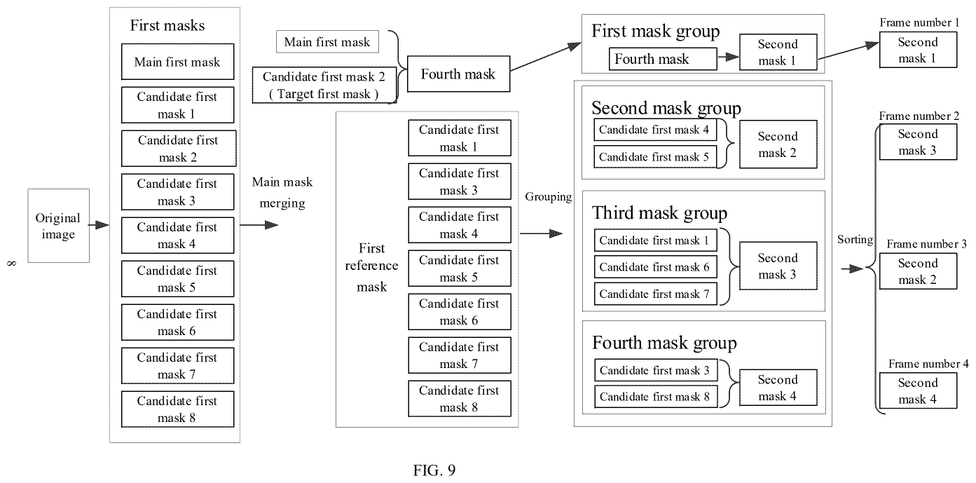

For example, referring to FIG. 9, supposing that elements in the original image include a main element and candidate elements. Based on the original image, a total of nine first masks are determined, including one main first mask and eight candidate first masks (that is, candidate first mask 1 to candidate first mask 8); after determining the candidate first mask 2 as the target first mask, the main first mask and the target first mask are first merged to obtain a fourth mask, and the fourth mask corresponds to the main element. Subsequently, the fourth mask participates in the compositing of the second mask 1, and the second mask 1 is the main second mask. Except for the candidate first mask 2, the other candidate first masks are all first reference masks. All of the first reference masks are grouped and subsequently composited, to obtain a second mask 2, a second mask 3, and a second mask 4. When sorting the second masks, the second mask 1 is at the first position in the second mask sequence, and the second masks from 2 to 4 are sorted according to the score.

Further, it may be set that the total number of frames of the target video is M, and the elements in the original image include the main element and the candidate elements. And if the number of the first masks is greater than the total number of frames, after determining the main first mask and a plurality of candidate first masks among the plurality of first masks, whether the ratio of the area of the main first mask to the area of the original image is greater than or equal to a preset area threshold is determined. If the area of the main first mask is greater than or equal to a preset area threshold, the step of “determining a target first mask among the plurality of candidate first masks based on an overlapping relationship between the main first mask and the candidate first masks; compositing the main first mask and the target first mask to obtain a fourth mask” is not executed, and subsequently all the candidate first masks are grouped to obtain M−1 mask groups.

For example, referring to FIG. 8, if the total number of frames of the target video is 4, it is determined that the first masks include one main first mask and eight candidate first masks, and since the ratio of the area of the main first mask to the area of the original image is greater than a preset area threshold, the main first mask and the candidate first mask are not merged, and subsequently when the first masks are grouped, the main first mask is divided into one group, and all the candidate first masks are divided into three mask groups. Subsequently, the first-frame image is obtained based on the main first mask, and the second-frame image to the fourth-frame image are obtained based on the remaining mask groups.

If the ratio of the area of the main first mask to the area of the original image is less than a preset area threshold, a step of “determining a target first mask among the plurality of candidate first masks based on an overlapping relationship between the main first mask and the candidate first masks; compositing the main first mask and the target first mask to obtain a fourth mask” is executed. Subsequently, among the candidate first masks, the remaining candidate first masks after excluding the target first mask are grouped to obtain M−1 mask groups.

Referring to FIG. 9, for example, if the total number of frames of the target video is 4, it is determined that the first masks include one main first mask and eight candidate first masks, and since the ratio of the area of the main first mask to the area of the original image is less than a preset area threshold, the main first mask and the target first mask are merged. Subsequently, when the first masks are grouped, the fourth mask is divided into one group, and the candidate first mask 1, the candidate first mask 3 to the candidate first mask 8 are divided into three mask groups. Subsequently, the first-frame image is obtained based on the fourth mask, and the second-frame image to the fourth-frame image are obtained based on the remaining mask groups.

In the above technical solution, optionally, the preset area threshold is specified in advance, and the present disclosure does not limit the specific value of the preset area threshold. Exemplarily, the preset area threshold may be set to 0.75.

Further, before S240, the method further include: in response to an overlapping pixel being included between the first masks having an adjacent relationship, performing ownership assignment on the overlapping pixel, so as to enable any two of the first masks to be non-overlapping; and/or; in response to an unoccupied pixel being included between the first masks having an adjacent relationship, performing ownership assignment on the unoccupied pixel, so as to enable that there is no unoccupied pixel between any two of the first masks.

The performing ownership assignment on the overlapping pixel refers to re-determining which first mask the overlapping pixel belongs to. After the performing ownership assignment on the overlapping pixel, the pixel belongs to only one first mask. In practice, it can randomly determine which first mask the overlapping pixel belongs to.

In some embodiments, optionally, if the first mask is a gray image, that is, in the first mask, the pixel value is any one of 0-255. When the overlapping pixel is included between the first masks having the adjacent relationship, the ownership of the overlapping pixel is determined based on the gray value of the overlapping pixel in two first masks, so that the overlapping pixel is assigned to the first mask with the maximum gray value. For example, when the first mask A3 and the first mask A4 have an adjacent relationship, the first mask A3 and the first mask A4 both include a pixel a, but in the first mask A3, the gray value of the pixel a is 250. In the first mask A4, the gray value of the pixel a is 133, and the pixel a is assigned to the first mask A3. That is, it is considered that the element corresponding to the first mask A3 occupies the position of the pixel a, while the element corresponding to the first mask A4 does not occupy the position of the pixel a.

The performing ownership assignment on the unoccupied pixel refers to re-determining which first mask the unoccupied pixel belongs to. It requires that after the performing ownership assignment on the unoccupied pixel, the pixel only belongs to one first mask, and there is no unoccupied pixel between the two first masks. In practice, it can randomly determine which first mask the unoccupied pixel belongs to.

In some embodiments, optionally, a dilation operation may be performed on two first masks in the same round, so that the indicated range of the two first masks gradually expands and the originally unoccupied pixel is annexed. In this process, the unoccupied pixel is assigned to the first mask that annexes it first. In this process, when a certain unoccupied pixel is simultaneously annexed by two first masks, the pixel can be assigned to any first mask.

In practice, due to the influence of factors such as the accuracy of the element identification algorithm and identification logic, there may be overlapping areas between different first masks and/or gaps between different first masks, and if all the first masks are merged, there may be a problem that the whole original image cannot be covered. In view of this, by performing ownership assignment on the overlapping pixel and/or the unoccupied pixel, any two first masks cannot overlap each other and have no gap, which can ensure that in the subsequent target video, there is no obvious noise point in the video picture of the target video with the continuous introduction of elements.

Based on the above-described technical solutions, optionally, after S120, the method further includes: performing a morphological opening operation on the first masks; and S130 may include: determining a correspondence between the first masks after the morphological opening operation and the frame numbers of the target video.

In practice, there may be small, scattered and unstable mis-segmentation regions in the first mask obtained directly based on the original image, which constitute the noises of the first mask. The existence of these noises may affect the judgment of the adjacency relationship between the first masks in the first mask grouping stage, and then affect the grouping result of the first masks. By performing a morphological opening operation on the first mask, noise in the first mask can be removed.

In practice, the performing a morphological opening operation on the first masks, for example, may involve preprocessing the first mask so that the size of the first mask meets the size requirement of the input image of the morphological opening operation model, and then by using the morphological opening operation model, the preprocessed first mask is first eroded and then dilated.

It can be understood that before using the technical solutions disclosed in various embodiments of present disclosure, users should be informed of the types, scope of use, use scenarios, etc. of personal information involved in present disclosure in an appropriate way according to relevant laws and regulations and be authorized by users.

For example, in response to receiving the user's active request, prompt information is sent to a user to clearly remind the user that the requested operation will require obtaining and using the user's personal information. Therefore, the user can independently choose whether to provide personal information to software or hardware such as electronic devices, applications, servers or storage media that perform the operation of the technical solution of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above process of notifying and obtaining user authorization is only schematic, and does not limit the implementation of the present disclosure. Other ways to meet relevant laws and regulations can also be applied to the implementation of the present disclosure.

It should be noted that the above-described method embodiments are described as a series of combinations of operations for simplicity of description, but those skilled in the art should know that the present disclosure is not limited by the described sequence of operations, because according to the present disclosure, some steps may be performed in other sequences or simultaneously. Secondly, those skilled in the art should also understand that the embodiments described in the specification are preferred embodiments, and the acts and modules involved are not necessarily necessary for the present disclosure.

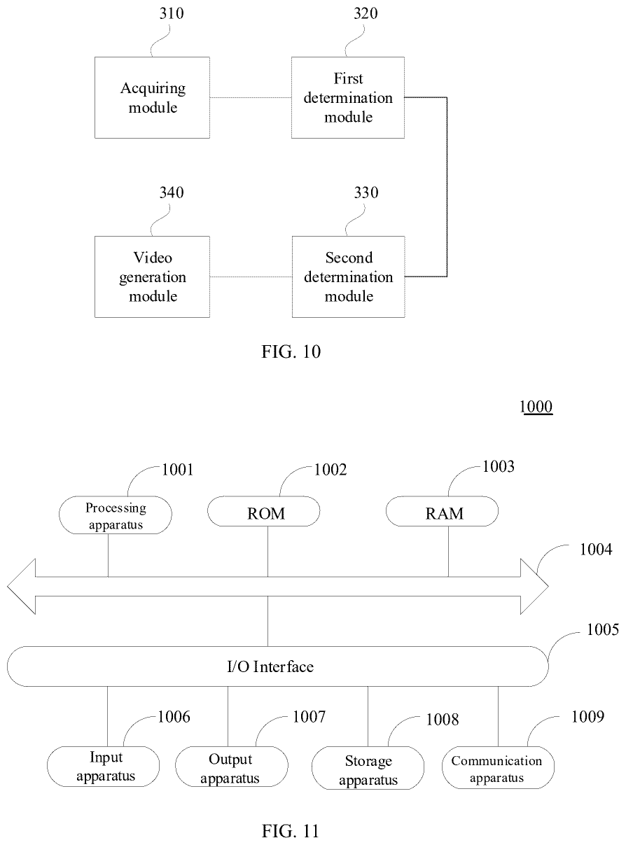

FIG. 10 is a schematic structural diagram of an image processing apparatus provided by an embodiment of the present disclosure. The image processing apparatus provided by the embodiment of the present disclosure may be configured in a client or may be configured in a server. Referring to FIG. 10, the image processing apparatus specifically includes:
an acquiring module 310, configured to acquire an original image, wherein the original image includes a plurality of elements;
a first determination module 320, configured to obtain a plurality of first masks based on the original image, wherein different first masks correspond to different elements;
a second determination module 330, configured to determine a correspondence between the first masks and frame numbers of a target video; and
a video generation module 340, configured to obtain the target video, based on the correspondence between the first masks and the frame numbers of the target video, and the original image, wherein in the target video, with a gradual progress of each frame of a picture, new elements continuously emerge.

Further, the second determination module 330 is configured to:
determine a total number of frames included in the target video;
in response to a number of the first masks being greater than the total number of frames, group the first masks to obtain a plurality of mask groups, so as to enable a total number of the mask groups to be equal to the total number of frames;
merge each first mask in a same mask group to obtain a second mask; and
determine a correspondence between second masks and the frame numbers of the target video.

The video generation module 340 is configured to:
obtain the target video, based on the correspondence between the second masks and the frame numbers of the target video, and the original image.

Further, the second determination module 330 is configured to:
determine an adjacency relationship between different first masks, and areas of the first masks; and
group the first masks, based on the adjacency relationship between the different first masks and/or the areas of the first masks, to obtain the plurality of mask groups.

Further, the second determination module 330 is configured to:
determine a key point based on the original image;
determine a score of each of the second masks based on the key point, wherein the score of each of the second masks is configured to characterize a distance between the second mask and the key point;
sort the second masks based on the score of each of the second masks to obtain a second mask sequence; and
determine the correspondence between the second masks and the frame numbers of the target video based on a position of each of the second masks in the second mask sequence.

Further, the second determination module 330 is configured to:
determine the key point based on a position of the main element in the original image;
determine a target second mask and candidate second masks in the second masks, wherein the target second mask corresponds to the main element, and the candidate second masks correspond to the candidate elements;
determine a score of each of the candidate second masks based on the key point;
determine that the target second mask has a sequence number of 1 in the second mask sequence; and
for any one candidate second mask of the candidate second masks, determine a sequence number of the candidate second mask in the second mask sequence, based on a score of the candidate second mask and/or an adjacency relationship between the first candidate second mask and a reference second mask, wherein the reference second mask is a second mask whose sequence number has been specified in the second mask sequence.

Further, the total number of frames of the target video is M, and the video generation module 340 is configured to:
enable n equal to 1, and repeat a following merging step to obtain a third mask corresponding to a frame number n until n=M, wherein the merging step includes: merging all the second masks corresponding to frame numbers from 1 to n to obtain the third mask;
perform matting on the original image based on the third mask to obtain a first image corresponding to the third mask; and
splice the first image corresponding to the third mask based on a correspondence between the third mask and the frame number to obtain the target video.

Further, the total number of frames of the target video is M, the elements of the original image include a main element and candidate elements, and the second determination module 330 is configured to:
in response to the number of the first masks being greater than the total number of frames, determine a main first mask and a plurality of candidate first masks among the plurality of first masks, wherein the main first mask corresponds to the main element, and the candidate first masks correspond to the candidate elements;
determine a target first mask among the plurality of candidate first masks based on an overlapping relationship between the main first mask and the candidate first masks;
composite the main first mask and the target first mask to obtain a fourth mask;
take the fourth mask as a mask group;
determine a number of at least one first reference mask, wherein the first reference mask is a remaining candidate first mask after excluding the target first mask from all the candidate first masks; and
in response to the number of the at least one first reference mask being greater than M−1, group the at least one first reference mask to obtain M−1 mask groups.

Further, the second determination module 330 is configured to:
before the grouping the first masks to obtain a plurality of mask groups, in response to an overlapping pixel being included between the first masks having an adjacent relationship, perform ownership assignment on the overlapping pixel, so as to enable any two of the first masks to be non-overlapping; and/or,
in response to an unoccupied pixel being included between the first masks having an adjacent relationship, perform ownership assignment on the unoccupied pixel, so as to enable that there is no unoccupied pixel between any two of the first masks.

Further, the second determining module 330 is configured to: after the obtaining a plurality of first masks based on the original image, perform a morphological opening operation on the first masks;
the determining a correspondence between the first masks and frame numbers of a target video includes:
determining a correspondence between the first masks after the morphological opening operation and the frame numbers of the target video.

The image processing apparatus provided by the embodiment of the present disclosure can execute the steps executed by client or server in the image processing method provided by the embodiment of the method of the present disclosure, and has the execution steps and beneficial effects, and will not be repeatedly described here.

FIG. 11 is a schematic structural diagram of an electronic device provided by an embodiment of the present disclosure. Referring to FIG. 11, FIG. 11 illustrates a schematic structural diagram of an electronic device 1000 suitable for implementing some embodiments of the present disclosure. The electronic devices 1000 in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, a smart home device or the like. The electronic device illustrated in FIG. 11 is merely an example, and should not pose any limitation to the functions and the range of use of the embodiments of the present disclosure.

As illustrated in FIG. 11, the electronic device 1000 may include a processing apparatus 1001 (e.g., a central processing unit, a graphics processing unit, etc.), which can perform various suitable actions and processing according to a program stored in a read-only memory (ROM) 1002 or a program loaded from a storage apparatus 1008 into a random-access memory (RAM) 1003 to realize an image processing method according to an embodiment of the present disclosure. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatus may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a storage apparatus 1008 including, for example, a magnetic tape, a hard disk, or the like; and a communication apparatus 1009. The communication apparatus 1009 may allow the electronic device 1000 to be in wireless or wired communication with other devices to exchange information. While FIG. 11 illustrates the electronic device 1000 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts, thereby realizing the image processing method as described above. In such embodiments, the computer program may be downloaded online through the communication apparatus 1009 and installed, or may be installed from the storage apparatus 1008, or may be installed from the ROM 1002. When the computer program is executed by the processing apparatus 1001, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The information signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital information in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
acquire an original image, wherein the original image includes a plurality of elements;
obtain a plurality of first masks based on the original image, wherein different first masks correspond to different elements;
determine a correspondence between the first masks and frame numbers of a target video; and
obtain the target video, based on the correspondence between the first masks and the frame numbers of the target video, and the original image, wherein, in the target video, with a gradual progress of each frame of a picture, new elements continuously emerge.

Optionally, when the above one or more programs are executed by the electronic device, the electronic device can also perform other steps described in the above embodiment.

The computer program codes for performing the operations of the present disclosure may be written in one or more programming languages or a combination thereof. The above-mentioned programming languages include but are not limited to element-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, the present disclosure provides an electronic device, and the electronic device includes:
one or more processor;
a memory, configured to store one or more programs;
when the one or more programs are executed by the one or more processors, the method according to any one provided by the present disclosure is implemented by the one or more processors.

According to one or more embodiments of the present disclosure, the present disclosure provides a computer-readable storage medium, wherein the computer-readable storage medium stores at least one computer program, and the computer program, when executed by a processor, is configured to implement the method according to any one provided by the present disclosure.

The embodiment of the present disclosure also provides a computer program product, which includes at least one computer program or instruction, and the computer program or instruction, when executed by a processor, is configured to implement the image processing method as described above.

It should be noted that in this paper, relational terms such as “first” and “second” are only used to distinguish one entity or operation from another entity or operation, and do not necessarily require or imply that there is any such actual relationship or order between these entities or operations. Moreover, the terms “include”, “comprise” or any other variation thereof are intended to cover non-exclusive inclusion, so that a process, method, article or device including a series of elements includes not only those elements, but also other elements not explicitly listed or elements inherent to such process, method, article or device. Without further restrictions, an element defined by the phrase “include one”, “comprise one” does not exclude the existence of other identical elements in the process, method, article or device including the element.

What has been described above is only the specific embodiment of the present disclosure, so that those skilled in the art can understand or implement the present disclosure. Many modifications to these embodiments will be obvious to those skilled in the art, and the general principles defined herein can be implemented in other embodiments without departing from the spirit or scope of the present disclosure. Therefore, the present disclosure will not be limited to the embodiments described herein, but is to be accorded the widest scope consistent with the principles and novel features disclosed herein.

1. An image processing method, comprising:
acquiring an original image, wherein the original image comprises a plurality of elements;
obtaining a plurality of first masks based on the original image, wherein different first masks correspond to different elements;
determining a correspondence between the first masks and frame numbers of a target video; and
obtaining the target video, based on the correspondence between the first masks and the frame numbers of the target video, and the original image, wherein, in the target video, with a gradual progress of each frame of a picture, new elements continuously emerge.

2. The method according to claim 1, wherein the determining a correspondence between the first masks and frame numbers of a target video comprises:
determining a total number of frames comprised in the target video;
in response to a number of the first masks being greater than the total number of frames, grouping the first masks to obtain a plurality of mask groups, so as to enable a total number of the mask groups to be equal to the total number of frames;
merging each first mask in a same mask group to obtain a second mask; and
determining a correspondence between second masks and the frame numbers of the target video; and
the obtaining the target video, based on the correspondence between the first masks and the frame numbers of the target video, and the original image, comprises:
obtaining the target video, based on the correspondence between the second masks and the frame numbers of the target video, and the original image.

3. The method according to claim 2, wherein the grouping the first masks to obtain a plurality of mask groups comprises:
determining an adjacency relationship between different first masks, and areas of the first masks; and
grouping the first masks, based on the adjacency relationship between the different first masks and/or the areas of the first masks, to obtain the plurality of mask groups.

4. The method according to claim 2, wherein the determining a correspondence between second masks and the frame numbers of the target video comprises:
determining a key point based on the original image;
determining a score of each of the second masks based on the key point, wherein the score of each of the second masks is configured to characterize a distance between the second mask and the key point;
sorting the second masks based on the score of each of the second masks to obtain a second mask sequence; and
determining the correspondence between the second masks and the frame numbers of the target video based on a position of each of the second masks in the second mask sequence.

5. The method according to claim 4, wherein, in response to the elements of the original image comprising a main element and candidate elements, the determining a key point based on the original image comprises:
determining the key point based on a position of the main element in the original image;
the determining a score of each of the second masks based on the key point comprises:
determining a target second mask and candidate second masks in the second masks, wherein the target second mask corresponds to the main element, and the candidate second masks correspond to the candidate elements; and
determining a score of each of the candidate second masks based on the key point; and
the sorting the second masks based on the score of each of the second masks to obtain a second mask sequence comprises:
determining that the target second mask has a sequence number of 1 in the second mask sequence; and
for any one candidate second mask of the candidate second masks, determining a sequence number of the candidate second mask in the second mask sequence, based on a score of the candidate second mask and/or an adjacency relationship between the first candidate second mask and a reference second mask, wherein the reference second mask is a second mask whose sequence number has been specified in the second mask sequence.

6. The method according to claim 2, wherein the total number of frames of the target video is M, and the obtaining the target video, based on the correspondence between the second masks and the frame numbers of the target video, and the original image, comprises:
enabling n equal to 1, and repeating a following merging step to obtain a third mask corresponding to a frame number n until n=M, wherein the merging step comprises: merging all the second masks corresponding to frame numbers from 1 to n to obtain the third mask;
performing matting on the original image based on the third mask to obtain a first image corresponding to the third mask; and
splicing the first image corresponding to the third mask based on a correspondence between the third mask and the frame number to obtain the target video.

7. The method according to claim 2, wherein the total number of frames of the target video is M, the elements of the original image comprise a main element and candidate elements, and the in response to a number of the first masks being greater than the total number of frames, grouping the first masks to obtain a plurality of mask groups, so as to enable a total number of the mask groups to be equal to the total number of frames, comprises:
in response to the number of the first masks being greater than the total number of frames, determining a main first mask and a plurality of candidate first masks among the plurality of first masks, wherein the main first mask corresponds to the main element, and the candidate first masks correspond to the candidate elements;
determining a target first mask among the plurality of candidate first masks based on an overlapping relationship between the main first mask and the candidate first masks;
compositing the main first mask and the target first mask to obtain a fourth mask;
taking the fourth mask as a mask group;
determining a number of at least one first reference mask, wherein the first reference mask is a remaining candidate first mask after excluding the target first mask from all the candidate first masks; and
in response to the number of the at least one first reference mask being greater than M−1, grouping the at least one first reference mask to obtain M−1 mask groups.

8. The method according to claim 2, wherein, before the grouping the first masks to obtain a plurality of mask groups, the method further comprises:
in response to an overlapping pixel being comprised between the first masks having an adjacent relationship, performing ownership assignment on the overlapping pixel, so as to enable any two of the first masks to be non-overlapping; and/or,
in response to an unoccupied pixel being comprised between the first masks having an adjacent relationship, performing ownership assignment on the unoccupied pixel, so as to enable that there is no unoccupied pixel between any two of the first masks.

9. The method according to claim 1, wherein, after the obtaining a plurality of first masks based on the original image, the method further comprises:
performing a morphological opening operation on the first masks, wherein
the determining a correspondence between the first masks and frame numbers of a target video comprises:
determining a correspondence between the first masks after the morphological opening operation and the frame numbers of the target video.

10. An electronic device, comprising:
one or more processor;
at least one memory, configured to store one or more programs, wherein
when the one or more programs are executed by the one or more processors, an image processing method is implemented by the one or more processors, wherein the method comprises:
acquiring an original image, wherein the original image comprises a plurality of elements;
obtaining a plurality of first masks based on the original image, wherein different first masks correspond to different elements;
determining a correspondence between the first masks and frame numbers of a target video; and
obtaining the target video, based on the correspondence between the first masks and the frame numbers of the target video, and the original image, wherein, in the target video, with a gradual progress of each frame of a picture, new elements continuously emerge.

11. The electronic device according to claim 10, wherein the determining a correspondence between the first masks and frame numbers of a target video comprises:
determining a total number of frames comprised in the target video;
in response to a number of the first masks being greater than the total number of frames, grouping the first masks to obtain a plurality of mask groups, so as to enable a total number of the mask groups to be equal to the total number of frames;
merging each first mask in a same mask group to obtain a second mask; and
determining a correspondence between second masks and the frame numbers of the target video; and
the obtaining the target video, based on the correspondence between the first masks and the frame numbers of the target video, and the original image, comprises:
obtaining the target video, based on the correspondence between the second masks and the frame numbers of the target video, and the original image.

12. The electronic device according to claim 11, wherein the grouping the first masks to obtain a plurality of mask groups comprises:
determining an adjacency relationship between different first masks, and areas of the first masks; and
grouping the first masks, based on the adjacency relationship between the different first masks and/or the areas of the first masks, to obtain the plurality of mask groups.

13. The electronic device according to claim 11, wherein the determining a correspondence between second masks and the frame numbers of the target video comprises:
determining a key point based on the original image;
determining a score of each of the second masks based on the key point, wherein the score of each of the second masks is configured to characterize a distance between the second mask and the key point;
sorting the second masks based on the score of each of the second masks to obtain a second mask sequence; and
determining the correspondence between the second masks and the frame numbers of the target video based on a position of each of the second masks in the second mask sequence.

14. The electronic device according to claim 13, wherein, in response to the elements of the original image comprising a main element and candidate elements, the determining a key point based on the original image comprises:
determining the key point based on a position of the main element in the original image;
the determining a score of each of the second masks based on the key point comprises:
determining a target second mask and candidate second masks in the second masks, wherein the target second mask corresponds to the main element, and the candidate second masks correspond to the candidate elements; and
determining a score of each of the candidate second masks based on the key point; and
the sorting the second masks based on the score of each of the second masks to obtain a second mask sequence comprises:
determining that the target second mask has a sequence number of 1 in the second mask sequence; and
for any one candidate second mask of the candidate second masks, determining a sequence number of the candidate second mask in the second mask sequence, based on a score of the candidate second mask and/or an adjacency relationship between the first candidate second mask and a reference second mask, wherein the reference second mask is a second mask whose sequence number has been specified in the second mask sequence.

15. The electronic device according to claim 11, wherein the total number of frames of the target video is M, and the obtaining the target video, based on the correspondence between the second masks and the frame numbers of the target video, and the original image, comprises:
enabling n equal to 1, and repeating a following merging step to obtain a third mask corresponding to a frame number n until n=M, wherein the merging step comprises: merging all the second masks corresponding to frame numbers from 1 to n to obtain the third mask;
performing matting on the original image based on the third mask to obtain a first image corresponding to the third mask; and
splicing the first image corresponding to the third mask based on a correspondence between the third mask and the frame number to obtain the target video.

16. The electronic device according to claim 11, wherein the total number of frames of the target video is M, the elements of the original image comprise a main element and candidate elements, and the in response to a number of the first masks being greater than the total number of frames, grouping the first masks to obtain a plurality of mask groups, so as to enable a total number of the mask groups to be equal to the total number of frames, comprises:
in response to the number of the first masks being greater than the total number of frames, determining a main first mask and a plurality of candidate first masks among the plurality of first masks, wherein the main first mask corresponds to the main element, and the candidate first masks correspond to the candidate elements;
determining a target first mask among the plurality of candidate first masks based on an overlapping relationship between the main first mask and the candidate first masks;
compositing the main first mask and the target first mask to obtain a fourth mask;
taking the fourth mask as a mask group;
determining a number of at least one first reference mask, wherein the first reference mask is a remaining candidate first mask after excluding the target first mask from all the candidate first masks; and
in response to the number of the at least one first reference mask being greater than M−1, grouping the at least one first reference mask to obtain M−1 mask groups.

17. A non-transitory computer-readable storage medium storing at least one computer program, wherein the computer program, when executed by a processor, is configured to implement an image processing method, wherein the method comprises:
acquiring an original image, wherein the original image comprises a plurality of elements;
obtaining a plurality of first masks based on the original image, wherein different first masks correspond to different elements;
determining a correspondence between the first masks and frame numbers of a target video; and
obtaining the target video, based on the correspondence between the first masks and the frame numbers of the target video, and the original image, wherein, in the target video, with a gradual progress of each frame of a picture, new elements continuously emerge.

18. The non-transitory computer-readable storage medium according to claim 17, wherein the determining a correspondence between the first masks and frame numbers of a target video comprises:
determining a total number of frames comprised in the target video;
in response to a number of the first masks being greater than the total number of frames, grouping the first masks to obtain a plurality of mask groups, so as to enable a total number of the mask groups to be equal to the total number of frames;
merging each first mask in a same mask group to obtain a second mask; and
determining a correspondence between second masks and the frame numbers of the target video; and
the obtaining the target video, based on the correspondence between the first masks and the frame numbers of the target video, and the original image, comprises:
obtaining the target video, based on the correspondence between the second masks and the frame numbers of the target video, and the original image.

19. The non-transitory computer-readable storage medium according to claim 18, wherein the grouping the first masks to obtain a plurality of mask groups comprises:
determining an adjacency relationship between different first masks, and areas of the first masks; and
grouping the first masks, based on the adjacency relationship between the different first masks and/or the areas of the first masks, to obtain the plurality of mask groups.

20. The non-transitory computer-readable storage medium according to claim 18, wherein the determining a correspondence between second masks and the frame numbers of the target video comprises:
determining a key point based on the original image;
determining a score of each of the second masks based on the key point, wherein the score of each of the second masks is configured to characterize a distance between the second mask and the key point;
sorting the second masks based on the score of each of the second masks to obtain a second mask sequence; and
determining the correspondence between the second masks and the frame numbers of the target video based on a position of each of the second masks in the second mask sequence.
